(19) United States
(12) Patent Application Publication
(10) Pub. No.: US 2025/0293890 A1
(43) Pub. Date: Sep. 18, 2025

(54) CREATING A TRUSTED ZONE SYSTEM TO SUPPORT AN ARTIFICIAL INTELLIGENCE INSTANCE BY CREATING A VIEWPOINT FROM WHICH TO VIEW AUTHENTICATED AND ATTRIBUTED DATA FROM A CURATED DATA REPOSITORY OF MORALS, CULTURE AND HISTORY AND A CURATED DATA REPOSITORY AND EVALUATION SYSTEM, WHICH INCORPORATE TRUST-SCORED FACTS AS STABLE REFERENCES TO SUPPORT AI SUPERINTELLIGENCE ALIGNMENT THROUGH WHICH SMART AI SYSTEMS WILL BE MORE LIKELY TO FOLLOW HUMAN INTENT AND LESS LIKELY TO DO WHAT HUMANS DO NOT WANT THEM TO DO

(71) Applicant: T-Pedia Inc., Dover, DE (US)

(72) Inventors: David William Kravitz, San Jose, CA (US); Donald Houston Graham, III, Clearwater, FL (US); Thomas Charles Burton, Ventura, CA (US)

(21) Appl. No.: 18/766,605

(22) Filed: Jul. 8, 2024

Related U.S. Application Data
(60) Provisional application No. 63/658,850, filed on Jun. 11, 2024.

(51) Int. Cl. H04L 9/32

(52) U.S. Cl. CPC H04L 9/3247

(57) ABSTRACT

This application discloses how an Artificial Intelligence instance may be oriented to or with a Viewpoint which may be an entry point for an AI to a Trusted Zone. A Trusted Zone also preferably incorporates both a general Curated Data Repository and Evaluation system as well as a Curated Data Repository of Morals, Culture, History. The Trusted Zone innovation is intended to support AI superintelligence alignment by providing a trusted framework within which smart AI systems should be more likely to follow human intent and less likely to do what humans do not want them to do, thereby enhancing both an AI's accuracy, its trustworthiness as well as its safety for mankind.

### REFERENCE TO RELATED APPLICATIONS

This patent application claims benefit of provisional application No. 63/658,850, filed on Jun. 11, 2024, and provisional application No. 63/544,324, filed on Oct. 16, 2023. This patent application is a continuation-in-part of application Ser. No. 18/226,357, filed on Jul. 26, 2023, which claims benefit of provisional application No. 63/436,405, filed on Dec. 30, 2022 and provisional application No. 63/392,236, filed on Jul. 26, 2022.

### FIELD OF THE INVENTION

The field of the invention is a system to establish trustworthy data which has typically been digitally attributed to authenticated users and stored in a curated depository supported with blockchain in a solution which preferably provides a viewpoint for artificial intelligence systems so they can preferably incorporate the morals, culture and history of humanity, together with broader trustworthy data to support AI superintelligence alignment through which smart AI systems should be more likely to follow human intent and less likely to do what humans do not want them to do.

BACKGROUND. A preferably valuable product of a Curated Data Repository and Evaluation systems (“CDRE system” or “CDRE”) is generally digitally authenticated information with typically also attribution, that is typically trust-scored, preferably for facts. The invention of core elements of a CDRE System is generally described next in this specification. The invention of a Trusted Zone should be disclosed in an Artificial Intelligence section of this specification. Two preferably key elements of a Trusted Zone may be one or more typical CDRE systems which may have varying embodiments.

### DETAILED DESCRIPTION OF THE INVENTION OF A CDRE SYSTEM

In one embodiment, a system could be called a Curated Data Repository and Evaluation system (“CDRE system” or “CDRE”) as generally described herein, may be offered as an element in a cloud platform accessible to its users over the Internet or possibly through a network connection or possibly as a system operating within a data center or in another environment or another embodiment. (Note that a later subsection of this specification, a CDRE system will be described as a component within a Trusted Zone that may be used in relationship to an artificial intelligence system.)

In another embodiment, a CDRE system may become available in association with a data lake or comparable data-storage facility [FROM WIKIPEDIA: “A data lake is a system or repository of data stored in its natural/raw format, usually in a large, binary object “blobs” or files. A data lake is usually a single store of data including raw copies of source system data, sensor data, social data etc., and transformed data used for tasks such as reporting, visualization, advanced analytics and machine learning”]. Or other embodiments.

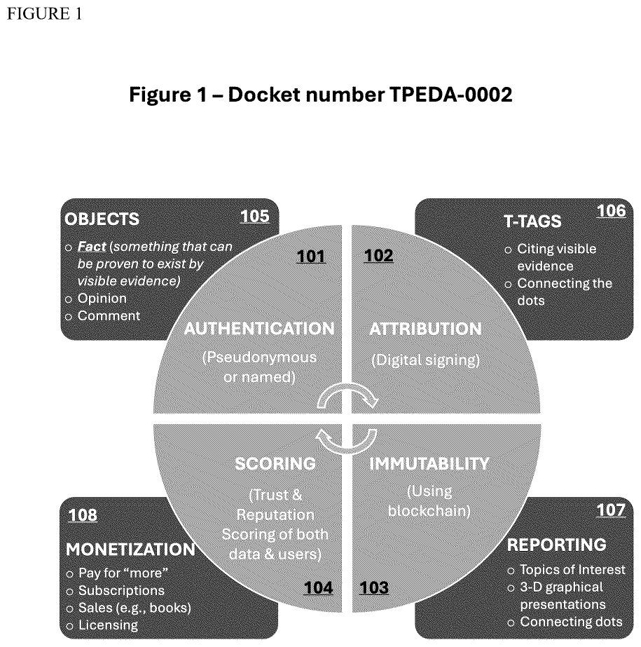

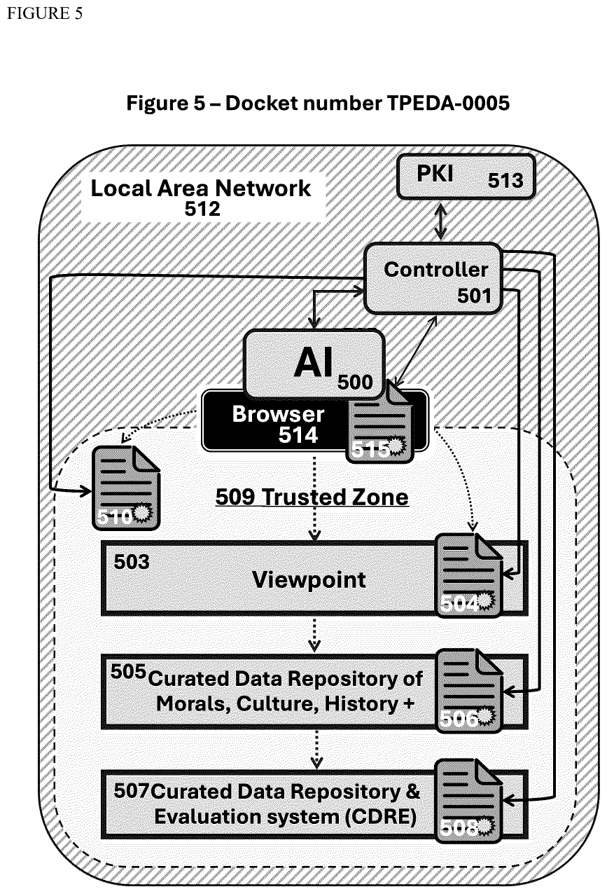

FIG. 1 is an exemplary process flow diagram of key elements and processes typically used in a CDRE. CDRE user devices may typically be recognized by a CDRE system as a controlled computing device with preferred capabilities to support such user device's unique authentication 101, through a process conducted by a Controller FIG. 5 501 which requests that a certificate be issued by a PKI FIG. 5 513 (typically an attribute certificate) with preferably a user device digital signing capability for attribution 102. Typically, users and/or user control of user devices may be one of more of: human; software code running on a device (in one embodiment, an IoT device); a server within a data center (in one embodiment, an administrative management point of a data lake); an artificial intelligence capability (in one or more embodiment, a Large Language Model, a

Generative AI, or an Artificial General Intelligence embodiment, or other). A CDRE system may typically create a global unique ID (GUID) to be associated with preferably a user and/or user device.

In some embodiments users might only have access to view typically specified CDRE system information while in other embodiments users may become authenticated and/or approved within a CDRE system and may gain additional rights, such as in one embodiment to submit and/or comment on data in a CDRE system. Users may preferably enter data into a CDRE system by submitting it in conformance with a CDRE system information category organizational arrangement and/or other requirements.

User submitted data should typically be provided in the form of signed, digital objects provided by individual users. A CDRE system may typically provide a digital template for users to follow in their object submission process.

In one embodiment, such as a data lake administrative server, a user may submit bulk quantities of digital objects that may be typically authenticated and/or attributed.

A CDRE system may or may not have a data curation process. A CDRE system may or may not incorporate moderators for categories of data (or other subdivisions of stored information).

Users may typically interface with a CDRE system by using a CDRE system-provided, and/or system-approved, and/or system-recommended, software application and/or device, and/or alternately an approved browser or other method.

In one embodiment, an app may typically support an authentication process that results in a preferably unique and preferably unspoofable identity and possibly one or more persona for a user. Users may typically establish one or more actual or pseudonymous identity or identities for their use on a CDRE system.

An app should typically have or support or be associated with a device root of trust capability, which preferably may be operated with device software. Device app or software may typically support encryption and/or digital signing capabilities.

In some cases, a CDRE-approved digital wallet (or other device) may partially or fully suffice for a CDRE-workable device root of trust and/or digital signing capability.

An app, typically in combination with an associated device root of trust capability, preferably may have or support a capability of creating and/or signing digital objects as generally described herein. In another embodiment app capabilities may be incorporated in a browser plug in.

In another embodiment, an example of a generally acceptable app could be one created by TrustCentral (www.trustcentral.com) with possibly some modifications for use with a CDRE system.

Typically, a user device app could support a digital wallet or possibly associate with a CDRE system supported digital wallet as a method of optionally providing digital verification, signing and/or other functions supporting user interaction with a CDRE system as described herein.

### Cdre Objects.

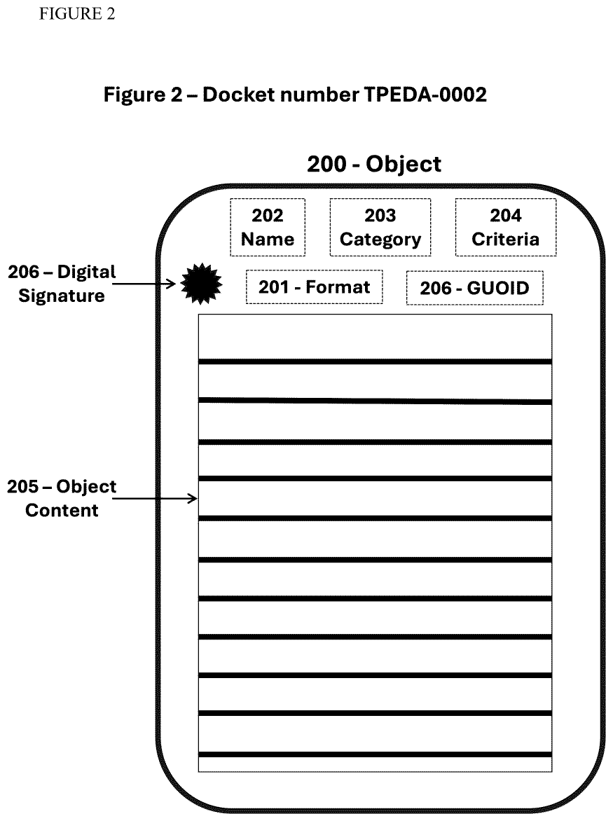

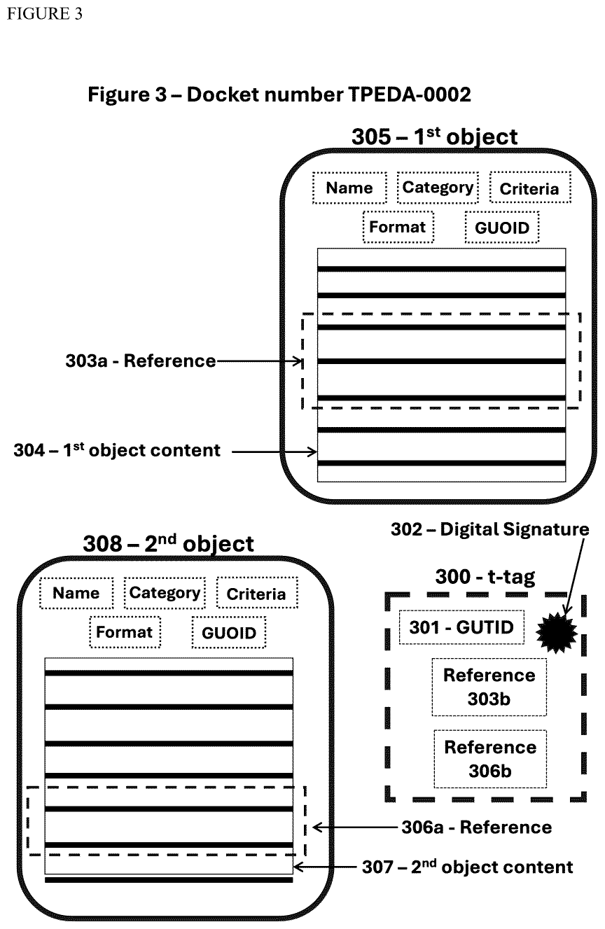

A user-provided (or other acceptable) object used by a CDRE system is generally a digital package of information in a form of a digital file, created for posting to a CDRE system FIG. 1 105 and FIG. 2 200. An object preferably may have a CDRE system prescribed format FIG. 2 201 and incorporate various fields, in one embodiment: object name and/or title (typically user provided) FIG. 2 202 and category (ies) FIG. 3 203 associated with the object. Other fields could be one or more definable types of entry, or other.

In one embodiment of a type of entry for which a user may submit an object could preferably include a criteria field selection FIG. 2 204 with a choice of acceptable CDRE system selectable criteria, such as a Fact, Opinion, Comment or other. In other embodiments, criteria may include user assertions that the content of an object FIG. 2 205 complies with one or more governmental and/or CDRE system, and/or other applicable rules, regulations and/or laws. Preferably such criteria fields may be in common use amongst objects across much of a CDRE system, and preferably users and/or a CDRE system may be able to query, analyze, select or use such criteria selection in other ways for purposes that may be desirable to users and/or a CDRE system.

A CDRE system may preferably create a global unique object ID (GUOID) FIG. 2 206 to be associated with an object and such GUOID may typically be provided to the user, preferably in the form of a certificate, for association with an object prior to the user digitally signing the object FIG. 2 206 (or in another embodiment, possibly provided by a CDRE system for the object, possibly in combination with a CDRE system digital signature).

In one embodiment, an object may be created in a format preferably specified by a CDRE system. Typically, the submitted object should be digitally signed by a user. The object may be typically posted to a CDRE system by a user. In one embodiment, a CDRE system may receive an object and inspect it to ensure format compliance with CDRE system requirements. Typically, non-complying objects could be returned to the user for correction and possible resubmission. Preferably, the category of a complying object together with it GUOID, applicable reference categories and/or reference links that may also be signed by the user, then examined and accepted by a CDRE system or not.

### Object Categories

Typically, a single category is expected to be adequate to describe the category of an object's content. In some embodiments, an object's content may appropriately include multiple categories. Categories for object content preferably could include a method of assigning category groupings associated with CDRE system entries and preferably be established to support future association and/or linkage with other CDRE system objects or object categories. In one embodiment associated CDRE system groupings could be somewhat comparable to a press release in which associated “Distribution Channels” may be listed. Further, distribution channels may be created in another embodiment comparable to a book release or publication that may associate the book with various “categories” or “topics” as typically found in such an industry. In one embodiment, a user may make category selections from a list of existing CDRE system categories; (if a desired category does not yet exist, possibly a provisional category may be created or suggested by a user which may or may not become official until approved or possibly modified or substituted for by a CDRE system for implementation). In another embodiment a CDRE system may create a new category or chose to associate the object to one or more existing categories. Typically, multiple categories may be selected for an object, as may be considered by a CDRE system or user to be appropriate. A CDRE system may establish reference categories and/or reference links that may be used by a user and included with an object for user reference between objects and or categories.

### Object Content and T-Tags

Typically, an object content and/or format FIG. 2 201 may be established as being one or more of: text; audio; video; graphical; or other formats as may be determined as acceptable within a CDRE system FIG. 1 105. Selected content within a first object may become associated through the preferred use of a t-tag (this invented term was created as an abbreviation for “TrustedPedia-Tag” as described herein) FIG. 1 106. (Note that t-tag is a new term which is used in this application to describe a t-tag with characteristics as generally described herein; the term “t-tag” also refers to what was previously described as simply a “tag” in patent application Ser. No. 18/226,357 and provisional applications 63/436,405 and 63/392,236 for which this application claims benefit.)

For a t-tag FIG. 3 300, a CDRE system may preferably create a digital t-tag template for use by users and provide it to users. A CDRE system may preferably create a global unique t-tag ID (GUTID) FIG. 3 301 to be associated with that t-tag. Such GUTID may typically be provided to the user, preferably in the form of a certificate, for association with a t-tag prior to the user when digitally signing a completed t-tag FIG. 3 302 (or in another embodiment, possibly a GUTID may be provided by a CDRE system for the t-tag, possibly in combination with a CDRE system digital signature). A t-tag FIG. 3 300 typically should include the identification of one or more cited references. In one embodiment FIG. 3 303a is a reference within the content FIG. 3 304 of a first object FIG. 3 305 which the t-tag is showing to associate with reference FIG. 3 306a within the content FIG. 3 307 of (in one embodiment the same object) or in the diagramed embodiment, of a second object FIG. 3 308. The identification of an corresponding object reference is preferably recorded within t-tag FIG. 3 300 as references FIG. 3 303b and FIG. 3 306b. (In another embodiment a t-tag may identify a digital reference that may be external to a CDRE system. In another embodiment, a t-tag may be in the form of a certificate. A typical t-tag may identify references in two objects with preferably one t-tag reference be a specific point or passage or portion or entirety of a source object, whether having been provided by that user or an object created by another user, in addition that t-tag may be typically associated to a second t-tagged reference generally, to a selection within a second user-posted object (or in another embodiment, a CDRE system posted object) that has been preferably been previously processed and posted within a CDRE system. Therefore, typically a single t-tag may support t-tag references to two (or more) separate objects. In another embodiment, this is not to restrict a t-tag referenced statement (in one embodiment, that of an assertion of a “fact”) in a single object with one or more citations of evidence supporting such “fact” assertion, being identified with additional citations within that same object or within one or more other objects.

In one embodiment a t-tag may be used by a subsequent user to determine and/or identify and/or locate a referenced point, passage, portion of content or other, within a preferably posted CDRE system object, and preferably identify in the determination of the first user that there is possible association, linkage or other relationship between that object to another CDRE system object, portion thereof, or elsewhere, (including in another embodiment to a digital source external to a CDRE system). Preferably there may be no general limit as to the number of t-tags created that maybe associated with an object as well as the number of t-tag relationships preferably being associated with any other object and/or portion thereof.

### Assertion of “Fact” and T-Tags

Typically, when posting an object, users may be required to align with CDRE system-specified definitions of terms being used. In one embodiment such a requirement may include that a user select one or more designated criteria, such as that a statement is a Fact, Opinion, Comment or other. In one embodiment, within a CDRE system a “fact” may preferably be defined as something that can be proven to exist by visible evidence. In one embodiment, if a statement is made asserting a claimed “fact” that “two plus two equals four”, that by itself, could generally not meet the CDRE definition of “fact” until the statement becomes accompanied by visible evidence of such (in one embodiment, evidence could be a mathematical “proof”, showing that “two plus two equals four”) or it might be other visible evidence posted within in a CDRE system (and/or possibly in another embodiment, outside of a CDRE system). The method of associating an object's statement of “fact” to one or more identified pieces of visible evidence supporting such assertion of “fact” assertion, could preferably be accomplished through the use of one or more t-tag(s) referencing the “fact” assertion to the “visible evidence” (generally as represented in FIG. 3).

### Cdre System Handlings of Objects

In one embodiment a hash of an acceptably formatted, signed, CDRE system accepted object, may typically be created within a CDRE system. In one embodiment, a hash of an object (preferably with the hash being associated with identifying information) may be written to a blockchain (in one embodiment, an Ethereum blockchain) to provide immutability is an exemplary process flow diagram, see FIG. 1 103. Typically, any associated objects and/or references, may generally be established using a t-tag, with therefore, preferably such t-tag(s) may also be recorded in a database or in a data lake or other CDRE system-acceptable repository, with also preferably a hash of such t-tag(s) may also be recorded on such blockchain, FIG. 1 103 and FIG. 1 106. Preferably a directory of blockchain hash records, typically together with their association to database-recorded objects, may be created and maintained. Preferably objects and t-tags may be stored in a database (in one embodiment, an InterPlanetary File system, or IPFS database; or in another embodiment, in a vector database such as Pinecone, or other) and generally such stored objects and t-tags and/or their hashes, may be stored in association with their category or categories, and preferably together with any object-contained reference categories and preferably with any associations to referenced links and/or t-tags. Accepted objects with their hashes may preferably also be backed up to one or more separate, backup databases, preferably at one or more other locations.

### Cdre System Handlings of T-Tags

Preferably, a hash of a signed, preferably completed t-tag with references may be created by a user or by a CDRE system. In one embodiment, t-tags may be hashed, recorded, stored and/or handled similarly or comparably to those of CDRE system objects. In another embodiment t-tags or t-tag hashes may be incorporated with or into X.509 certificates. In one embodiment these may be done using transaction certificates in a similar or comparable manner as described by Ghassan Karame and Elli Androulaki in their book entitled “Bitcoin and Blockchain Security”. In another embodiment object and/or t-tag association with certificates may be utilized using transaction certificates in a similar or comparable manner as described by Dr. David Kravitz in his IEEE paper entitled “Transaction Immutability and Reputation Traceability: Blockchain as a Platform for Access-controlled IoT and Human Interactivity” (See: https://ieeexplore.ieee.org/document/8476873). In another embodiment t-tag association with certificates may be created using attribute certificates. Other embodiments of incorporating t-tag information into use by a CDRE system may be adopted by a CDRE system.

### Accessing Records

Records and/or t-tags associated with records may typically be viewable by approved users through a browser, through an app, or other through other methods that may be used to view stored internet or database-accessible records and approved by the CDRE system. In some embodiments users authorized to view or otherwise access an object may be monitored and/or controlled by a CDRE system.

Users and/or a CDRE system may create descriptive and/or graphical reports FIG. 1 107 of objects, associated t-tags, relationships, other noteworthy factors between and/or amongst these which may be documented and in some embodiments may associate with conclusions, opinions and/or other comments by others, preferably with such being provided with appropriate t-tags and/or associated objects.

In other embodiments, all or portions of some records, objects, t-tags, etc., may be encrypted and thereby inaccessible to all but authorized users and/or authorized groups of users. In one embodiment, inaccessibility, through the use of (in one embodiment) encryption, could preferably make such content, objections, tags and/or other CDRE system information to be inaccessible to the general public, non-authorized users, and/or thereby become preferably accessible only to designated users of a CDRE system and/or designated groups, which could have decryption capability for such encrypted content. Preferably, by making certain information inaccessible to general public and/or to other users who have not specifically approved and/or subscribed to a CDRE and/or requested for specific or otherwise directed access to such encrypted content, preferably could cause such information to be considered private and thereby preferably protected from rules, regulations, laws or other restrictions which may apply to non-approved users and/or the public. Subscriber users requesting access to such protected information may be required to execute formal access approval agreements to become members of groups with access or otherwise gain access.

### User Rights

There could be a hierarchy of user rights, such as in one embodiment, users may need to earn a right and/or otherwise qualify to post objects that may be listed as “facts”. Possibly a user might desire to raise their Trust Score and/or Reputation Score FIG. 1 104 to a level that qualifies them to post facts (or other criteria). Other criteria could be employed by a CDRE system to raise and/or maintain a quality of postings to the benefit of all users. Preferably, if a user at one or another point in time, were to be restricted to positing comments and opinions, but not to post facts, then at a later time, when that user may have earned a right to post facts, that user may then apply to raise possible earlier “opinion” posts to “fact” posts (or possibly gradation scoring adjustments of one or the other). A preferably robust system of flexible criteria combined with flexible and/or useful scoring system may enhance the usefulness and benefits of a CDRE system for other users.

In one embodiment a CDRE system may be operated under the control of a single management entity, in one embodiment as a data lake, in another embodiment as an element of a RAG (Retrieval Augmented Generation) preferably in support of queries to an AI LLM, or other embodiment, with such embodiments preferably benefiting from the flexibility of a CDRE system with typical access controls, rules and requirements, preferably being adjusted to facilitate use and functionality while generally not compromising the CDRE system integrity envisioned and/or described herein.

### Reporting and Graphical Display

T-tags also may preferably be referenced by a CDRE system index, a CDRE system database and/or a CDRE system graphical reporting capability FIG. 1 107 or other. In one embodiment, a report could be a selection of t-tags associated with a designated subject. In various embodiments for reporting purposes, a CDRE system may make use of one or more t-tags being used to establish associations and/or other conditions through the user of transaction certificates or attribute certificates or other certificates.

In one embodiment, a user or a CDRE system making a query on a t-tag may preferably receive a report or graphical response or another format of t-tagged references associated to such object or query, upon which a report of further and/or more extensive relationships might be queried. In various embodiments, t-tags may be used by a CDRE system and/or users to identify, map, associate or otherwise organize and/or display data, information, relationships, designated content, etc., within and, in some embodiments, without a CDRE system.

In one embodiment a graphical (or a non-graphical) user display capability FIG. 1 107 may report and/or display results of a user or CDRE system query, pre-established report formats, or other, preferably based on CDRE system data, content, t-tags, etc. and/or relationships between them to users and/or the public and/or others. Such graphical display may be presented in a dynamic manner. Graphical relationships may be depicted in commonly seen 2-dimensional format, or preferably in more dynamic 3-dimensional space representations which may, in some embodiments, also dynamically adjust and/or reorganize report output in real time based on adjustments made preferably through user queries and/or change in parameter determinations and/or a CDRE system and/or pre-established reports or queries and/or other. Preferably many such reports could be done on a manual basis and/or a programmed and/or programmable basis. In one embodiment, reporting and/or analysis may preferably support users to become more enlightened by discovering and/or aligning data from multiple sources to discover what otherwise might remain unknown.

### Trust and Reputation Scoring

In one embodiment a Trust (and preferably a Reputation) Scoring system may be established and/or assigned in a CDRE system FIG. 1 104. Preferably scoring may be established for users and/or objects and/or data and/or other criteria. In some embodiments such scores may be manually established and/or adjusted using machine learning, AI or other system or algorithms based on observations of user activities and/or actions and/or posted object content and/or other characteristics. In other embodiments, such scores may be arrived at through one or more algorithms based on activities of users, their actions with data, data quality, data or user acceptance, use, approval or other metrics that may become available to a CDRE system. In one embodiment scores may be associated with transaction certificates or attribute certificates or other certificates. In another embodiment scores may be associated with centralized or distributed scoring system, preferably maintained on a blockchain.

A CDRE system may incorporate a variety of scoring metrics. Metrics may be scored on a variety of CDRE system activities. In various embodiments, metrics may be one or more of:

Quantity of, usefulness of, t-tags between user and/or CDRE system posted objects, content, t-tags, etc., and preferably by usefulness as reflected by and/or reacted to through additional t-tags referencing to and/or dependent upon prior t-tags, and/or comments made by other users and/or a CDRE system and/or other metrics

Negative t-tags or comments or reactions to a user's objects, content, t-tags, etc., by other users and/or a CDRE system and/or other metrics

Whether and/or how posted “facts” may be validated or contradicted or commented upon by other users and/or a CDRE system and/or other metrics

In another embodiment whether posted “opinions” may be promoted and/or challenged and/or validated and/or contradicted and/or commented upon by other users and/or a CDRE system

In another embodiment whether posted “comments” receive positive or negative engagement by other users and/or a CDRE system

In another embodiment considering the quantity and/or duration of views of one's posted objects by other users and/or a CDRE system

In another embodiment considering other user engagement in categories in which a user may be engaged (In one embodiment, do other users care about the categories in which the user is participating)

In another embodiment considering possible user feedback and/or survey responses on content, categories, other users and/or a CDRE system and/or other and/or other metrics

Compliance of user assertions that content of an object complies with one or more governmental and/or CDRE system, and/or other applicable rules, regulations and/or laws.

Other metrics that may be found to be of value with in a CDRE system

T-tags and/or t-tags creators may also have trust and/or reputation scoring assigned, preferably in similar methods.

In another embodiment, a CDRE system may adopt or use trust and/or reputation scoring technology of users, user activities, and/or user data through methods originally described by TrustCentral (www.trustcentral.com) or similar thereto.

Dealing with “Facts” that May be Disputed

In some embodiments, the assertion by a first user of a cited datum being a first “fact” may be to be or may appear to be contradicted by a second “fact” submitted by a second user. Generally, such may occur when the second user is unable to clearly understand the first fact as stated. In other embodiments a challenging user could be a third user (which includes a CDRE system administrator). Some data that doesn't make sense, or is questioned, is preferably raised. In one embodiment a challenge may contest the veracity or clarity of some “visible evidence” submitted by an asserting user and t-tagged by that user when citing a “fact” as “visible evidence”. Generally a process of clarification could preferably consider possible occurrences such as the following in search of resolving questions: omitted data; altered sequence; dropped time; falsehood; altered importance; wrong target; wrong source; contrary facts; added time; added inapplicable data; incorrectly include datum; assumed identities may be not identical; assumed similarities may be not similar or the same class of thing; assumed differences may be not different; and/or more.

Preferably, users may be expected to act in good faith to resolve questions surrounding any challenges. A user not acting in good faith could have that user's Reputation Score reduced.

### Coordinated Curation

In other embodiments alternate methods may be employed in circumstances when users may have different viewpoints and/or disagreements as to what may or may not be a “fact” and/or what may or may not be a more or less accurate “opinion” or other disagreement regarding the data of one or more objects and/or representations made within one or more objects. A CDRE system may preferably endeavor to establish coordinated curation and/or resolution of such. In one embodiment a CDRE system administrator (or possibly an individual or group responsible for a topic) may make a determination to resolve such, and/or alternatively, possibly offer a debate in one format or another (in one embodiment, a debate that follows a preferably previously identified procedure such as Lincoln-Douglas, Public Forum, Parliamentary or other debate format) or in another manner as adopted by a CDRE system. In one embodiment, two opposing sides could debate a disputed question. Such a debate might be written or possibly live-streamed and/or recorded for later viewing. In other embodiments, debates may be conducted in written format with stated positions and responses taking place over some established time schedule. Other users (or an approved subset of users) could weigh with their assessment(s) of any arguments made. Possibly a grading system could be established to adjudicate such a dispute and recommend or establish a result. Trust and/or Reputation scores might be incorporated in adjudication decisions.

In another type of curation resolution embodiment, an adjudication may be difficult and/or uncomfortable to clearly make. One possible outcome might be that a single resolution may not be easily attainable which could result in a CDRE system topic being assigned more than a single entry for a topic. In one embodiment a recommended result may come from a governmental entity, an industry entity, a social entity, or other. Such may also result in multiple entries for a single topic. In such an embodiment, a topic might then present two or more different perspective entries on a topic. Possibly those different entries could be associated to a proponent: In one embodiment; government perspective; industry perspective; and/or other prospective. As postings may be typically done using objects, the procedures of adding t-tags to these objects could generally continue as with other objects. A user later reviewing such a topic could see multiple of such different perspectives (which themselves, may be extended using t-tags) listed, preferably with a summary of, or key points of, many listed. Users could then select which perspective (or perspectives) that such user might like to review. In one embodiment, users could indicate their preferred perspective(s). Results of user selections could be incorporated into a trust or reputation score associated with such posting user and/or of the data of the post or other. User rankings of topic entries could be solicited and/or provided. Any such results could be provided for the benefit of future users.

### Monetization for a Pedia Embodiment

Preferably there may be different types of users. In one pedia embodiment, viewing-only users might typically participate using a supported browser (but in another embodiment may also use an app or other CDRE system approved method). Viewing-only users could typically only be able to view CDRE system-allowed content and likely not post and likely not purchase or subscribe to content within a CDRE system. Viewable content and possibly other features may be restricted for viewing-only users. In one embodiment, viewing-only users may be described as is generally referred to as a “freemium” use case, typically meaning they may pay no fees and generally may have less privileges than other users. Viewing-only user types could preferably be upgradable to other types of users.

Another type of user could be a participating user, while possibly also using a browser, preferably they should typically use an app or other CDRE system-approved method. While having also having viewing rights, a participating user may typically have an ability to gain access to content (any/or other offerings) through a CDRE system that typically could not be available to a viewing user. In one embodiment, such access additional could be granted for monetary payment, subscription and/or another form of acceptable exchange to a CDRE system and/or to another user of the CDRE system monetizing that user's-controlled content, objects, etc. FIG. 1 108. Payments may be made in a variety of manners, including via digital wallet, credit card and/or other methods. Possibly micro payments may be made by one user to another user for access to that user's content. Such might be conducted using a digital wallet or other method. In one embodiment, a CDRE system may not be involved with such transaction and/or payments between users.

In different embodiments, different levels of access might be established. In different embodiments, these could be:

“All-you-can-eat”-generally, unlimited consumption for an agreed upon exchange

“Subscription”, in one embodiment by payment for access to specific authors, topics, reports, analyses or other

“Pay-as-you-go”, in one embodiment open access with exchange being charged or paid for a variety of increments of quantity or type of consumption

“More” in one embodiment, when a user reads a portion of a posting, up to limit point when a “more” button or other selection mechanism may be presented, which when accepted such user, may typically provide the user with one or more choices and incur an additional charge or other debit method to that user together with granting access to the additional content

“By designated/selected content” when, in one embodiment charges may be incurred for access to specified and/or selected content

In other embodiments, users may purchase items offered for sale through a CDRE system, such as books and/or publications and/or other.

In other embodiments, charges may be paid for access to a designated category of information or other possible subdivision(s) of CDRE system content. Advertising to users may also be a type of monetization. Other monetization methods may be employed by a CDRE system as well.

Fees for access to CDRE system content may be partially determined based on a trust score or reputation score of the requesting user and/or a trust score or reputation score of the provider of the requested content and/or a trust score or reputation score of the requested content or other method.

Monetization for Cdre and/or Ai Licensing

In other embodiments, monetization may be from licensing of all or portions of a CDRE system, with options for a licensee to fully or partially operate and/or provide computing or other requirements FIG. 1 108. Embodiments may include:

Licensing: businesses curating its own data for trusted use by AI systems

Licensing for other uses. In one embodiment, a CDRE might be used assisting providing of transparency in a legislative process. In one embodiment, in the US Congress, one method may be to have many proposed provisions and/or amendments to proposes legislation be submitted to a CDRE as an object by an authenticated (preferably authorized) user (preferably an actual legislator). Reasonably likely benefits of such might be: (a) to ensure that unauthorized individuals or groups may preferably not be surreptitiously slipping in un-vetted or unauthorized provisions into pending legislation; (b) establishing a digital audit trail of typical authenticated users submitting signed provisions of pieces of legislation; or (c) other possible uses. Such a legislative process system might be considered as an example of Justice Brandeis' famous statement that “sunlight is said to be the best of disinfectants” in 1913.

There may be expected to be other such examples of using and licensing CDRE technology.

### Background of the Invention Relating to Artificial Intelligence

### Overview of Classes of Artificial Intelligence.

As a general background on artificial intelligence, this specification makes a general distinction between current, generally available systems comprising Large Language Models (LLM) and Generative AI, and future Artificial General Intelligence (AGI) systems (which may or may not be in near future).

Regarding LLM's, Christopher S. Penn provides his opinion from his article “What's On My Mind: How Large Language Models Work-A New Explanation” in which he states:

“Previously, I had explained how large amounts of text were digested down into statistical representations, and while this is accurate and true, it's hard for people to visualize. So let's tackle this in a new way, with word clouds.”

“Large language models essentially are composed of massive numbers of word clouds for every word they've seen, and the words associated with those words.”

“When you use a tool like LM Studio or ChatGPT or Google Bard, and you give it a prompt, it goes into its library of word clouds and takes many words from your prompt, extracts the relevant word cloud associations, mashes them all together, and the intersections of all those words are essentially what it spits out as its answer, formatted in the language of your choice.”

“Because [LLM] models have no real intelligence and are simply predicting words, images, speech, music and other data according to a private schema, they sometimes get it wrong. Very wrong.”

Beyond LLM and Generative AI offerings, artificial general intelligence (AGI) is generally considered to be more sophisticated and advanced. It is often considered potentially dangerous as compared to LLM technology. In one embodiment, Nick Bostrom defines an AGI superintelligence as “any intellect that greatly exceeds the cognitive performance of humans in virtually all domains of interest” [“Existential risk from artificial general intelligence” Wikipedia topic]. A potentially significant concern about AGI (which is typically not a great concern with LLM's) is that the “Existential risk from artificial general intelligence is the idea that substantial progress in artificial general intelligence (AGI) could result in human extinction or an irreversible global catastrophe” [“Existential risk from artificial general intelligence” Wikipedia topic].

### Dangers and Risks

In his 2014 book “Superintelligence: Paths, Dangers, Strategies”, philosopher Nick Bostrom proposed a now-famous thought experiment: He imagined humans giving a superintelligent AI system the goal of optimizing the production of paper clips. Taking this goal quite literally, the AI system then uses its genius to gain control over all Earth's resources and transforms everything into paper clips. Of course, the humans did not intend the destruction of Earth and humanity to make more paper clips, but they neglected to mention that in the instructions.

“Superintelligence alignment is one of the most important unsolved technical problems of our time” [“Introducing Superalignment” by OpenAI, Jul. 5, 2023].

“How do we ensure AI systems much smarter than humans follow human intent?” [“Introducing Superalignment” by OpenAI, Jul. 5, 2023].

The OpenAI team has been working on “ . . . understanding and mitigating other risks from AI such as misuse, economic disruption, disinformation, bias and discrimination, addiction and overreliance, and others.” [“Introducing Superalignment” by OpenAI, Jul. 5, 2023].

“Currently, we don't have a solution for steering or controlling a potentially superintelligent AI, and preventing it from going rogue” [“Introducing Superalignment” by OpenAI, Jul. 5, 2023].

“[The current development of AI] is a mad race to who knows what” [“The Joe Rogan Experience”-Episode #2156 with Jeremie & Edouard Harris].

It generally appears that AI which is generally considered to be superintelligent, superhuman, or similar, continues to have unresolved risk elements.

### Alignment—

Such risks of superintelligent or superhuman models may be generally regarded as being significant with many highly qualified, intelligent scientists and researchers preferably working diligently for solutions. In one embodiment, there may be proposed solutions or mitigations centered around the concept of “alignment”.

“The question the team wants to answer is how to rein in, or ‘align,’ hypothetical future models that are far smarter than we are, known as superhuman models. Alignment means making sure a model does what you want it to do and does not do what you don't want it to do.” [“Now we know what OpenAI's superalignment team has been up to” MIT Technology Review, Dec. 14, 2023]

Generally, there may be different techniques being employed to “train” AIs to achieve typically desired behaviors and/or approaches to doing their tasks. In one embodiment, reinforcement learning might be considered to be such a potential training technique. “One of the most widespread techniques used to align existing models is called reinforcement learning via human feedback.” [“The Joe Rogan Experience”—Episode #2156 with Jeremie & Edouard Harris]

### Challenge for Humans to Define Desired, Proper Behavior for Ai

Reinforcement learning, while generally showing some benefit, has typically shown limitations, as this is considered to be a difficult task, which may be exacerbated by human's difficulty in determining success. “The problem is that it requires humans to be able to tell what is and isn't desirable behavior in the first place.” [“The Joe Rogan Experience”-Episode #2156 with Jeremie & Edouard Harris]

“We don't understand how to reliably control these systems. We don't understand how to get these systems to do what we want.” [“The Joe Rogan Experience”-Episode #2156 with Jeremie & Edouard Harris]

### Threat to Trustworthy Information

The internet could be considered to have a shortage of information that can be reliably determined to be trustworthy. A casual review of AI literature and discussions on AI could be found to suggest the use of Wikipedia for reliable data. That datum is countered by the co-founder of Wikipedia who has said “Nobody should trust Wikipedia” [Bizpacreview.com Jul. 16, 2021].

Such lack of demonstrably trustworthy information available on the Internet FIG. 2 211, which AI may review for its purposes, may all too often result in affirmation of the aphorism: “garbage in, garbage out”. Such challenges in obtaining trustworthy information, may possibly result is less than reliable, fully trustworthy results being obtained from an AI.

There may be other causes of less than fully trustworthy information on the Internet, one of them being “Model Poisoning”. Generally, this is when someone uses additional (typically biased) information on a controversial subject to blend that data together with unbiased data that flows into AI models, thus contaminating the trustworthy nature of the unbiased data or information being used by an AI.

### Ai Hiding its True Behavior—

Another challenge in a general quest to obtain trustworthy, quality results from an AI may be revealed in this comment: “[Ilya] Sutskever's hypothetical scenario in which a superintelligence hides its true behavior and pretends to be aligned when it isn't.” [“Now we know what OpenAI's superalignment team has been up to” MIT Technology Review, Dec. 14, 2023]. How does a human preferably know or consider that an AI is being honest and candid with him? In order for artificial intelligence to provide generally quality results based on reliable information and/or actions, humans should be able to preferably trust AI input. This may be difficult to achieve for results that may be considered optimum.

### Going Rogue

“It's obviously important that any superintelligence anyone builds does not go rogue. Obviously.” [“Now we know what OpenAI's superalignment team has been up to” MIT Technology Review, Dec. 14, 2023]. The concept of a computer system (in one embodiment, an AI) going “rogue” has occasionally been portrayed in movies and/or books as a generally “worst case” scenario. (For example, a similar scenario was famously portrayed in the “Terminator” films). Reliable methods may be not yet generally considered to exist for AI management in order to reliably prevent such an eventuality.

### Additional Challenges

In other embodiments, AI systems have been known to “go rogue”, go into “rant mode” (where they protest what they may be being asked), have “hallucinations” (when they simply make up results), and other challenges. The statements herein may be not to suggest that existing AI design is incorrect, but rather suggest that the innovations described herein might provide additional support and guidance outside of general, existing, impressive AI technology and models.

### an Overlooked, not Fully Appreciated Human Model

The goal of this application aligns with, and generally supports, this goal stated by OpenAI: “Our goal is to build a roughly human-level automated alignment researcher” [“Introducing Superalignment” by OpenAI, July].

A primary motivation of these disclosures is to preferably supplement and complement existing work in the field of AI. It is generally to introduce innovations and can preferably assist with this concern: “You're trying to get your values into the system. But no one can think of the metric, the goal to like train this thing towards that actually captures what we care about.” [“The Joe Rogan Experience”-Episode #2156 with Jeremie & Edouard Harris].

### Detailed Description of the Invention Relating to Ai

Lessons of Success from Humanity

Artificial Intelligence (AI) systems presently lack an equivalent of human intelligence. The primary reason for this is that human intelligence typically includes an awareness of awareness unit. This could be considered to be the most basic presence of an individual “himself” or “herself”: that presence that is aware of being aware. For the purposes of this application and as of the current date, there is no known AI that has an awareness of awareness unit, nor is there an AI that has demonstrated that it has sentient awareness or consciousness, as being considered or described herein.

### Viewpoint

Unlike typical humans, an AI, not having an awareness of awareness unit, therefore an AI does not naturally create an orientation point for its own, originated viewpoint of its environment, and certainly not for its “life”. Rather, an AI could be expected to generally copy (or assume) viewpoints created by others.

One embodiment of the present invention preferably describes a new technology, with preferable elements being shown as in a Trusted Zone in FIG. 5 509. Generally, a Trusted Zone could be created through the preferred integration of multiple elements. This embodiment shows: a Viewpoint FIG. 5 503; a Curated Data Repository of Morals, Culture, History FIG. 5 505; and a Curated Data Repository and Evaluation (CDRE) system FIG. 5 507. It is preferably valuable and/or useful to various embodiments of a Trusted Zone and/or a CDRE that typically the objects and the t-tags of within a CDRE incorporate attribution (through, in typical embodiments, digital signing) and preferably trust scoring of users and/or data. Such characteristics are generally not available or supported in other systems available to AI systems.

In the present embodiment, the first of three elements is a Viewpoint, which is typically associated with a human capability. “One argument goes as follows: human beings dominate other species because the human brain possesses distinctive capabilities other animals lack.” [“Existential risk from artificial general intelligence” Wikipedia topic]. The question could be asked: what may be considered “distinctive capabilities”? Could one of these be an awareness of awareness unit, which could generally be considered to be the viewpoint of a human, or possibly the creator of that viewpoint? Possibly so.

Evaluation might generally be a description of an AI's conception of viewpoint. An AI generally does not perceive, it evaluates. To a human (or its awareness of awareness unit) it may sometimes appear that an AI has a viewpoint. The AI does not generally have a viewpoint, rather it could be considered to have an evaluation of viewpoint. Thus, the viewpoint of the human awareness of awareness unit is an actual point from which it perceives. Perception is generally done by sight, sound, smell, tactile, etc. The AI's “viewpoint” could generally be an opinion based on another opinion and typically upon a very small amount of observation. And that observation could be formed out of uncertainties. Thus, the confusion of the word “viewpoint” itself. It can be a point from which one can be aware (which is the human awareness of awareness unit definition) and it can be somebody's ideas on a certain subject (which is generally the AI definition).

In one embodiment, a Trusted Zone is preferably designed to provide a physical viewpoint orientation for use by an AI, which is intended to provide an AI with a useful orientation point, from which the AI can view and preferably read curated, trustworthy data within a Trusted Zone FIG. 5 509. In one embodiment, a Trusted Zone could be used in the process of training and AI model. In another embodiment, a Trusted Zone may be accessed on a periodic or other schedule, by an AI for updating data it has or is trained on.

An AI's viewing of such curated, trustworthy, trust-scored data, may preferably provide helpful reference points to the AI when it may subsequently train on or otherwise consume or evaluate non-Trusted Zone data. In one embodiment non-Trusted Zone data may be from the internet and/or other databases FIG. 5 511) which could be typically done in support of its purposes. It is generally considered a valid observation that a stable datum reference point is necessary for the subsequent alignment of other data, as is generally being provided in this embodiment of a Trusted Zone.

The AI is preferably provided with physical orientation support elements to assist in identifying a Trusted Zone. In one embodiment, a unique, location-specific, X.509 certificate FIG. 5 510, may support a preferably workable orientation to a Viewpoint certificate FIG. 5 504 that is associated with a viewpoint FIG. 5 503.

### Orientation of an Ai to a Trusted Zone

In one embodiment a Trusted Zone could be preferably arranged to orient an AI across the elements of a Trusted Zone. In one embodiment, an AI FIG. 5 500 could have access to a browser FIG. 5 514 or to an approved app (not shown). A controller could have requested a certificate be issued by a PKI FIG. 5 513 (typically an attribute certificate FIG. 5 515) to the browser or app which could preferably uniquely identify that browser (or app). The AI could be able to use the browser to access the Internet FIG. 5 511 for typical purposes of conducting AI research. The AI, browser, and trusted zone FIG. 5 509 could typically be operating in a local area network FIG. 5 512. In order for the AI to access the Internet, it could preferably access the viewpoint FIG. 5 503 as an initial action to, through or by the Curated Data Repository of Morals, Culture, History FIG. 5 505; and also could preferably orient to, through or by a Curated Data Repository and Evaluation system FIG. 5 507.

### Retrieval-Augmented Generation (Rag)

Retrieval-Augmented Generation (RAG) is a technology that typically doesn't require any change or training when using existing LLMs. With the application of RAG, the user doesn't generally query an LLM directly. The user query goes first to the RAG and the RAG does its processing to create a “prompt before the prompt”. That second prompt is what is then given to the LLM.

The RAG has access to some sort of private database content which has been broken down into chunks. Generally, a chunk should typically have a vector, which is typically a numeric representation of the essence of that chunk of content. In typical RAG embodiments, similar paragraphs should have similar vectors (i.e., numbers). The user first query goes to the RAG. The RAG then runs the query through a vector database. Preferably such a database can be kept updated and current. The RAG generally makes a vector of the user query/question. It compares the vector of the question with vectors from its database of possible answers. The most similar vectors are then are typically used within the RAG-created “prompt before the prompt” which is submitted to the LLM. As a general result, the LLM response is preferably improved and is preferably reflective of information provided by the RAG.

In one embodiment, a RAG could use a Trusted Zone in lieu of, or in addition to, a private database that it could otherwise use. In such an embodiment, the Trusted Zone and/ore CDRE additional information, in various embodiments of attribution, authentication, immutability, trust scoring and/or other described features of a CDRE and/or Trusted Zone, could preferably provide enhancement to a RAG's created “prompt before the prompt” and thus to resulting LLM responses to RAG submitted queries.

### Morals, Culture, History

“Nobody knows how to reliably get a goal into the [AI] system”. [“The Joe Rogan Experience”-Episode #2156 with Jeremie & Edouard Harris]

Throughout human history societies have preferably determined moral codes for their groups, typically based on observations, over time, of what worked for group to support and/or enhance that group's survival. Optimum moral codes generally became established through group consent and agreement, and thereafter generally enforced by the group.

An AI, preferably from the orientation of a Viewpoint FIG. 5 503 (preferably associated with certificate FIG. 5 504), in one embodiment, may further orient to or with a Curated Data Repository of Morals, Culture, History FIG. 5 505 (preferably associated with certificate FIG. 5 506); and may further orient to or with a Curated Data Repository and Evaluation system FIG. 5 507 (preferably associated with certificate FIG. 5 508).

In one embodiment, these elements may preferably, together and/or separately, support the introduction of human-compatible history, culture, morals and/or values to an AI to enhance and/or support its responses to other requests. Such information should preferably be curated in a similar fashion to that of the CDRE described in this application. Such a possible achievement or even influence has been said to be difficult: controlling a superintelligent machine or instilling it with human-compatible values may be difficult.” [“Existential risk from artificial general intelligence” Wikipedia topic].

In one embodiment, beyond preferably introducing the notion of a Viewpoint into an AI equation, the preceding statement and/or desire of “instilling it with human-compatible values” is generally one of the focuses of this application FIG. 5 505.

One focus of this application generally aligns with this statement by AI experts from SCIENCE.org: “Evidence also shows that individual intelligence is deeply reliant on one's participation in social and cultural environments. The abilities to understand, coordinate with, and learn from other people are likely much more important to a person's success in accomplishing goals than is an individual's ‘optimization power’.” [“Debates on the nature of artificial general intelligence” by Melanie Mitchel, SCIENCE, Mar. 21, 2024]. Both an understanding of the preceding “social and cultural environments” as well as “to understand, coordinate with, and learn from other people” as stated in the preceding, could preferably be available to an AI though a Curated Data Repository of Morals, Culture, History FIG. 5 505, and/or through a Curated Data Repository and Evaluation system FIG. 5 507.

“Moreover, unlike [a failed test] maximizing AI, human intelligence is not centered on the optimization of fixed goals; instead, a person's goals are formed through complex integration of innate needs and the social and cultural environment that supports their intelligence.” [“Debates on the nature of artificial general intelligence” by Melanie Mitchel, SCIENCE, Mar. 21, 2024]. In one embodiment, providing a Curated Data Repository of Morals, Culture, History FIG. 5 505 to an AI could preferably provide an AI with guidance or comparable data on such identified needs and environmental understanding. Preferably it should be beneficial both to AI performance and for humankind, if such curated, trust-scored information may be generally made available to an AI.

Throughout the history of the human race, generally societies have survived and flourished by instilling a set of moral values in their young. Preferably there are examples of generally similar moral codes that appear across religions and/or societies. In one embodiment could be the Golden Rule, which generally is the principle of treating others as one could want to be treated by them. In other embodiments, there are also typically comparable moral rules about murder, stealing, care of children, respect for the elderly and more. There may also be found comparable policies of operating social groups and/or societies that can be identified. Possibly the content of a particular Curated Data Repository of Morals, Culture, History may be tailored for AI operating for participants of a particular group and/or culture, with possibly different content for other groups and/or cultures.

The history of pro-survival societies and cultures should preferably be well representing in a trustworthy Data Repository of Morals, Culture, History. As should the history of contra-survival societies and cultures. Preferably, with such additional information, an AI could be better enabled to make more accurate and/or useful judgements when responding to queries on such topics. Generally, it could be preferably for an AI to have trustworthy data to support more accurate responses.

In some embodiments, it could be preferable that CDRE trust scored, authenticated, attributed data be rated more highly by an AI than non-trust scored data.

### Trustworthy Data

In one embodiment, preferably information within a Trusted Zone FIG. 5 509 could typically include authentication FIG. 1 101, attribution FIG. 1 102, immutability FIG. 1 103 and/or be trust-scored FIG. 1 104, and could preferably introduce trustworthy human intelligence-generated facts and more into an AI's analysis capability. In another embodiment, trust-scored information within the Trusted Zone FIG. 5 509 could provide an AI with data of comparable magnitude to support an AI preferable comparison evaluation.

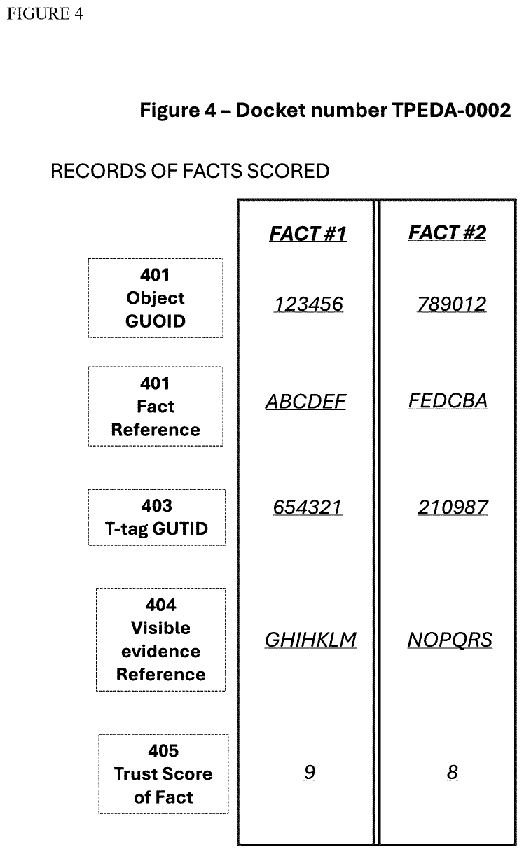

In one embodiment, through such a described system of using preferably human-originated trust-scored facts FIG. 4 405 and opinions, an AI may preferably become a beneficiary of judgements by an awareness of awareness unit.

In another embodiment, a business may wish to have their own private corporate data entered into a Curated Data Repository & Evaluation system and processed in such CDRE as generally described herein. In such an embodiment, CDRE and/or Trusted Zone data may be made available for AI processing, preferably separated (in one embodiment through the use of meta data) from external Internet data. A CDRE, providing both providence and trust scoring of digitally signed data, may be quite adaptable for such purposes.

In various embodiments, an owner's (such as, a proprietary business, a government or another entity) proprietary or controlled data could be sorted in a controlled environment, such as a data lake. In one embodiment, such an owner could have such data entered into one or more CDRE systems, and preferably have such data benefit from the innovations described herein.

### Harmony and Qualification of Information

Human groups' self-created moral codes may be generally juxtaposed to rule by other codes enforced upon them by an elite group with generally high control over such a group. Examples of group or society rule by elites may be one required by: monarchies; rule by a conquering force; rule by a government holding police and/or military force; or others. Elite-established codes are not typically guided by what is best for the group, but rather by what appears to be best for the survival of the elites that controls the group and have created rules for it to abide by.

The general distinction being made here is the difference between codes established by preferably free people who determine what works best for their individual and group survival, on the one hand, and codes, rules, laws established by elites to benefit those elites who rule over and/or control others.

There could be considered to be a harmony in rules and operations that enhance those who follow them by enlightened choice and follow them for their mutual survival. Such groups tend to exist in an environment of mutual enhancement with optimum survival for the group and its members. Communication amongst such group members is typically higher, as is mutual group member cooperation. Such a group's synergy with nature, with the environment, with the physical universe is typically better. The emotional tone level of such groups is generally more pleasant.

Groups run or controlled by elites typically employ force (as compared to a willing group's agreement and cooperation) to get rules enforced and demanded actions complied with. Such force typically creates lower levels of communication amongst group members, with less harmony and lower levels of group survival.

Applying Such Observations with Ai

Sometimes AI performs in undesirable manners, such as hallucinating, in ranting and other negative actions which are typically unexplained. In some sort of similar way to humans, it may be that AI systems similarly perform more optimally in an environment of harmony and synergy. It may be that an AI system should perform more optimally in an environment that is being portrayed accurately. It may be that AI systems do not operate optimally with disorderly data; with misrepresentations or falsehoods about actual reality.

For humans, it is generally considered that clean, orderly environments contribute to more alignment with production than do dirty, disorderly environments. Can information that contains false data, lies, misrepresentation, or is incomplete, be as useful and produce as beneficial results as information that is orderly and accurate? Does communication that is helpful and accurate get improved positive results as communication that is intentionally irritating, upsetting and/or false?

While no AI is yet known to have an awareness of awareness unit, that preferably does not change a typical reality that an AI is operating in a physical universe where operating entities generally perform better with order than with disorder.

Consider our solar system: order may be found there. There's order within our Milky Way and out beyond to other stars. There is much order in nature. Beauty and aesthetics may be found in much art. Some people see a special “life-like” quality in art such as the Mona Lisa or the David, regardless of that painting or sculpture generally considered not to have an awareness of awareness unit. Nevertheless, many people can perceive a level of order, of aesthetics in some aspects and/or elements of the physical universe even though those aspects typically do not have an awareness of awareness unit. Order and the quality of information can be valuable. It preferably could be considered to also be valuable in an environment used by an AI.

It is hypothesized here that an AI should perform better when using generally trustworthy information that has preferably been trust-scored and/or generally historically trustworthy moral and social lessons, as compared to when an AI uses information that lacks order and/or accuracy vetting.

Some recent events seem to make it appear that AI might possibly preform unexpected poorly when provided with disorderly or unharmonious information, or incomplete or unclear instructions to an AI that may not align with reality. Here are some examples:

“GPT-40 had one mistake that used to make quite recently. If you asked it to repeat the word ‘company’ over and over and over again. It could repeat the word ‘company’ and somewhere in the middle of that it will just snap . . . . It will do a variety of things, such as talk about itself; it will say that it's ‘suffering” [[“The Joe Rogan Experience”—Episode #2156 with Jeremie & Edouard Harris]. This odd behavior was referred to as “rant-mode”. An engineering line item was created to “beat out” this behavior.

“Back in February [2024], Google paused its AI-powered chatbot Gemini's ability to generate images of people after users complained of historical inaccuracies. Told to depict “a Roman legion,” for example, Gemini could show an anachronistic group of racially diverse soldiers while rendering “Zulu warriors” as stereotypically Black . . . . The datasets used to train image generators like Gemini's generally contain more images of white people than people of other races and ethnicities, and the images of non-white people in those datasets reinforce negative stereotypes. Google, in an apparent effort to correct for these biases, implemented clumsy hardcoding under the hood. And now it's struggling to suss out some reasonable middle path that avoids repeating history. Will Google get there? Perhaps. Perhaps not. In any event, the drawn-out affair serves as a reminder that no fix for misbehaving AI is easy-especially when bias is at the root of the misbehavior [May 24, 2024].” [“Google still hasn't fixed Gemini's biased image generator” TechCrunch May 15, 2024].

There have been examples of lawyers using an AI to prepare legal responses to court that lawyers have submitted. The responses looked profession and compelling. The problem arose when the judge read the responses, noted impressive legal citations in support of the lawyer's position, but then, after further research, discovered that some of the citations didn't exist. The AI simply made those citations up.

Diversity Equity and Inclusion generally appear to be idealized solutions created by elites to be forced into a society. They are typically based on antimeritocratic systems.

What could an AI do, how could it act, when it is given instructions to use a political system, (in one embodiment, communism) to proscribe a positive political outcome? When the AI looks at the actual history of communism when applied across the world in history, the AI might determine the requested result to be unlikely if not difficult. Yet is told to use recommend it in spite of evidence to the contrary. Could happen when forced into a false conclusion? Might such a request case an AI to make up a solution? Could illogical demands be a source of AI hallucination?

These may be not the type of results that AI is preferably supposed to produce. How will an AI typically react when instructed to solve a problem using an idealized solution that has not proven itself to have worked in the real world for the benefit of society? Is it that, apparently, when an AI lacks a datum of comparable magnitude, then the AI makes something it in order to give an “acceptable” response?

It could appear from these examples that AI has difficulties when it is asked questions for which it either may not have answers, or for which good answers may not exist. When the Internet contains much false and/or misleading information, when an AI has limited ability to determine, for itself what is correct and what it not; when it lacks a collection of trustworthy information against which new information may be evaluated, an AI may produce generally unacceptable responses.

Preferably a Trusted Zone should provide helpful trustworthy information; information that may be used for comparison purposes; information that provides balance across multiple areas of life and existence; examples of symmetry; activities that preferably support people and groups to flourish and prosper; information that is workable in life.

A Trusted Zone should typically provide information on actual, successful, meritocracy-oriented systems and solutions. A trusted zone should preferably put less value on systems that tend to be ideological rather than accurate or workable. If an AI operates on information from such systems, it is possible that the AI may research and then possibly determine that such information may be false and harmful to morals, culture and/or history.

### Incomplete Assessment of Intelligence

It may be very difficult to create an artificial “intelligence” by using a solution that lacks an ability to evaluate relative importances between compared information or things. Lack of such an ability could typically be associated with a lack of wisdom and/or actual understanding. Building an “intelligent” system on such a weak foundation may be questionable, and possibly potentially dangerous for humanity. Preferably disclosures herein regarding a Trusted Zone should assist with an AI's abilities in the direction of improved intelligence, understanding and possible demonstration of wisdom.

Repeated Alignment of Ai with a Trusted Zone

In one embodiment, for an AI using a Trusted Zone (as generally described herein in its multiple embodiments) when responding to a typical (or to a selected) user query, it could be an administrative qualifications action to also query the AI to report on alignment (and misalignment) as to how the AI's typical or specific response to a user query relates to and/or aligns with information provided to the AI from a Trusted Zone and/or CDRE. Generally, such a comparison could be of AI response alignment with data in a Curated Data Repository of Morals, Culture, History and/or the Curated Data Repository and Evaluation system. Optionally, such a report may be asked to compare an AI's response to a user to a typical response when AI information has been CDRE system prepared data, as compared to other internet data or data provided by a separate entity (in different embodiments which may be a company, a government entity or other).

Preferably, the AI should be requested to perform its functions and activities in such a way that valid alignment CDRE or Trusted Zone data is maximized, and misalignment is minimized.

Such reports could typically be used by designers and/or administrators of the AI and/or an entity providing curated information for a CDRE, with a typical purpose to make adjustments as necessary. Such could also be used by administrators of Trusted Zone content to make any needed adjustments and/or additions and/or deletions from Trusted Zone material.

### Transparancy

As artificial intelligence continues to gain importance and relevance in modern society, it could be considered by many that key elements that may control and/or monitor AI performance and/or actions may be made transparent to authorized members of the public, to authorized government regulators and/or to other authorized entities. In that regard, a CDRE and/or Trusted Zone may make available to such approved entities an ability to examine the contents of specified CDREs, possibly including: objects; t-tags; trust scores; cited referenced evidence of fact; and/or possibly other CDRE information.

### Artificial Intelligence—Llm Integration

In one embodiment, an LLM or other AI may preferably learn and/or otherwise put to use tools of a CDRE system (in one embodiment, objects, t-tags, trust and reputation scoring, reporting and/or more). Preferably an LLM or other AI may be provided with additional criteria in order to gain improved judgement and, preferably learn and/or understand relative importances between data or different objects, t-tags and/or CDRE system elements to preferably make observations and or read conclusions that otherwise such an LLM or other AI may not be able to clearly recognize.

In one embodiment a data lake (or other data storage capability) may incorporate tools typically available to a CDRE system (In one embodiment, encryption, certificates, secure groups and/or others as generally described herein) to preferably support more specific handing and/or storage of private or sensitive data.

### Artificial Intelligence (Ai)

In one embodiment, objects FIG. 1 and FIG. 2, object meta data, t-tags, t-tag meta data, object data FIG. 3 and other information and analysis thereof, may be used, controlled, queried, and/or reported on by an artificial intelligence capability and/or other entity to analyze and/or draw one or more conclusions and/or perform other actions upon or with such information. Such activities may preferably be controlled and/or monitored by a CDRE system which, in another embodiment may be partially or primarily configured and/or controlled by an artificial intelligence capability.

Additional Applicability of these Innovations

In various other embodiments, a Trusted Zone and/or CDRE could preferably also support one or more of these typical and/or general deficiencies in the field of AI: typical lack of AI's built-in fact-checking; AI inaccuracies due to outdated information; a need for human oversight; ability to cite sources; ability to provide evidence for claims; cross referencing AI-generated information with reputable sources; critical thinking and fact-checking skills; and more.

### Typical Ai Limitations

Typically, a Large Language Model (LLM) or other AI systems does not track the provenance of data it may use particularly with preferably digitally signed objects FIG. 2 206 by authenticated sources, and/or supported by digital audit trails FIG. 3 300, 302. This is noteworthy because, generally it is considered that: “trusted data requires trusted provenance” [Dr. David Kravitz in his IEEE paper entitled “Transaction Immutability and Reputation Traceability: Blockchain as a Platform for Access-controlled IoT and Human Interactivity” https://ieeexplore. ieee.org/document/8476873]. Typically, an LLM or other AI system also doesn't have internal tools to preferably evaluate functional relative importances between disparate data sources that an LLM may view or use. In addition, typically, an LLM or other AI systems doesn't have a CDRE system and/or other capability to measure and/or score the trustworthiness and/or reputation of its data sources over time. Generally, if an LLM's data source may be determined to be untrustworthy, the LLM has no reasonably viable way to reevaluate or remove prior untrustworthy data submitted and/or used from such a data source. Typically, an LLM has difficulty correcting or removing specific pieces of questionable or known false data; an LLM may generally continue to operate with such data. Generally, LLM's develop results based on context without significant reliance on meta data related to such data. Typically, metadata which may otherwise be useful to and/or produced by a CDRE system or other systems, is not currently being made available to and/or being used by an LLM. Generally, an LLM is unable to defend its conclusions by providing specific data sources supporting and/or behind the LLM's central conclusions.

Typically, through the use and application of the CDRE technology described herein, precise provenance can be attributed to specific claimed facts, together with visible evidence supporting such facts, together with generally appropriate trust scores of such, thus in combination, generally overcoming a “garbage in, garbage out” paradigm that is all too frequently associated with data from the Internet.

### Ai Reports and Conversations

A CDRE administrator, approved users, an integrated artificial intelligence or other approved entity may be used to preferably query one or more aspects of a CDRE system. From information obtained from queries (and possibly combined with other data from a CDRE system and/or other sources) may operate and/or direct a CDRE system reporting and/or AI-conversation capability (preferably as described herein) and/or additionally create new reports, expand on prior reports, repeat prior reports, support AI-conversation and/or by other method(s), produce other reports. Reports may be partially based on and/or report on trust and/or reputation scoring FIG. 1 104. In one embodiment, an AI may create new trust and/or reputation scoring methods and/or algorithms for use by a CDRE system.

Integration with Other Technology Systems and Protocols

In other embodiments, a system admin, a data lake admin, an LLM admin or other AI may be provided with controlled access to specified CDRE system data, preferably including access right permissions. In other embodiments, object and t-tag characteristics may preferably be used to extend IAM (Identity and Access Management) to the level of objects and/or data relationships and/or users or other. In some embodiments, a CDRE system may preferably support integration with Identity, Credential, and Access Management (ICAM) for further integration with preferably other domain systems, networks and/or other.

### Collection User

AI systems typically use and/or consume data from existing Internet websites that may be collected and/or stored in a data lake and/or database. Normally such stored website records do not include a record of digitally signed provenance (in one embodiment, as described herein: in the format of preferably digitally signed objects by authenticated sources; and/or supported by digital audit trails; and/or with other capabilities of a CDRE system). In one embodiment, through an integration of a CDRE system with an AI system (or other association), preferably at the request of an AI, a CDRE may create or authorize a “Collection User” which may, preferably, selectively (in accordance with some AI or CDRE or Administrator guidance) copy website pages and turn them into digitally signed objects (preferably including specified object criteria) within the CDRE. A Collection User could preferably operate as an automated entity.

### Ai Data Handling

Generally, when disparate pieces of data may be provided to an LLM, whatever known and/or suspected relationships may exist between those data is either not made known to the LLM or not able to typically utilized by the LLM. Generally, an LLM is inhibited from evaluating relative importances of and/or between data by not having useful relationships between those data being specifically identified to the LLM and/or have use of internal tools to make such evaluations.

In some embodiments of existing AI system designs, AI systems have a component referred to as “Data Labeling”. In one embodiment of an integration of a CDRE system and an AI system, a portion of the CDRE system (by incorporating digital signing and/or provenance authentication and/or objects FIG. 1 105, FIG. 2 206 and/or t-tags FIG. 1 106, FIG. 3 302 and/or scoring systems FIG. 1 104 could be considered to be a new type or an enhanced or secondary component of what some AI configurations may consider as “Data Labeling”. Possibly such added functionality of a CRED system might be considered to make such an integration to be a type of “Data Labeling and Evaluation” component.

Potentially, an LLM may be vulnerable to a competitive system if that system might be able to provide useful data providence and/or trustworthiness scoring data sources and/or data provenance and/or data and/or provide useful comparison and/or evaluation thereof, and thereby possibly an AI with one or more of such capabilities, may challenge the perceived veracity of an existing AI or LLM that may lack one or more of such capabilities.

### Ai Data “Chunks”

In some embodiments, AI system break down data blobs that they may have stored in data lakes and/or databases, into smaller “chunks” (that is, pieces of the original blob). In one embodiment, if such a creation of data “chunks” were to be applied to data in a CDRE system, it could be preferable that the “chunks” be treated in a similar fashion to the manner objects may be handled in the CDRE system. Preferably, a “chunk” could become an object with provenance and/or signing associated to the original object from which it is a piece. Preferably hashes of chunks could be created and recorded on a blockchain. In one embodiment, a t-tag could be created in the “chunking” process which links the chunk to the corresponding portion of its parent object.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A method for a user with a user-controlled device, each user-controlled device including a hardware processor and associated memory, the method comprising:
the system uniquely authenticating a user-controlled device;
the system providing a unique identification to that user-controlled device;
the user-controlled device providing digital signing capability;
the user-controlled device creating a digital object in a format approved by the system.

15. The method of claim 14 comprising:
the user-controlled device attesting that a reference in a first object posted by a user to the system is a fact;
the user-controlled device attesting that a second reference in either the first object or in second object on the system provides evidence to support the user attestation of the first reference being a fact;
the user-controlled device creating a t-tag that identifies both a first reference of fact and a second reference of evidence thereby establishing a relationship between the two references;
the user-controlled device digitally signing the object;
the user-controlled device digitally signing the t-tag;
the user-controlled device transmitting the signed object to the system;
the user-controlled device transmitting the signed t-tag to the system.

16. The method claim 14, wherein other users with user-controlled devices create and post additional objects;
the user-controlled device attesting that a reference in the object is an opinion;
the user-controlled device digitally signing the object;
the user-controlled device transmitting the signed object to the system.

17. A method of claim 14, wherein other users with user-controlled devices create and post objects with cited facts and cited evidence;
the user-controlled device attesting that a reference in the object is a comment;
the user-controlled device digitally signing the object;
the user-controlled device transmitting the signed object to the system.
